(19) United States
(12) Patent Application Publication
(10) Pub. No.: US 2025/0117682 A1
(43) Pub. Date: Apr. 10, 2025

(54) HIGH FIDELITY READOUT WITH TWO QUBITS

(71) Applicant: International Business Machines Corporation, Armonk, NY (US)

(72) Inventors: David C. Mckay, Ossining, NY (US); Ted Thorbeck, Elmsford, NY (US); Martin O. Sandberg, Ossining, NY (US)

(21) Appl. No.: 18/483,126

(22) Filed: Oct. 9, 2023

(51) Int. Cl. G06N 10/40; G06N 10/20

(52) U.S. Cl. CPC G06N 10/40; G06N 10/20

(57) ABSTRACT

Devices, systems and/or methods facilitating two qubit readouts are provided. In an embodiment, a system can comprise a data qubit; a coupler coupling the data qubit to a measurement qubit; and a measurement resonator coupled to the measurement qubit, wherein the measurement resonator is capable of transmitting a tone through the resonator to the measurement qubit.

### BACKGROUND

The subject disclosure relates to readouts for qubits, and more specifically to high fidelity readout with two qubits.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, devices, computer-implemented methods, and/or computer program products that facilitate high fidelity readout with two qubits.

According to an embodiment, a system can comprise a data qubit; a coupler coupling the data qubit to a measurement qubit; and a measurement resonator coupled to the measurement qubit, wherein a measurement tone applied to the measurement resonator acquires a change in phase or in amplitude that depends on the state of the measurement qubit. An advantage of such a system is that by separating the data qubit and the measurement qubit, the respective qubits can be optimized respectively for gate operations and readout operations, thereby eliminating the optimization tradeoffs of single qubit systems.

In one or more embodiments of the above-described system the measurement qubit can comprise a frequency tunable qubit. An advantage of such a device is that by utilizing a tunable qubit as the measurement qubit, the detuning between the measurement qubit and the measurement resonator can be optimized to minimize leakage during readout operations.

According to another embodiment, a method for measuring a qubit can comprise executing a measurement gate operation to entangle a data qubit to a measurement qubit, wherein the gate operation transfers measurement probabilities from the data qubit to the measurement qubit; and applying a measurement pulse to a measurement resonator coupled to the measurement qubit. An advantage of such a method is that it reduces the idle time of the data qubit during measurement operations, thereby reducing dephasing of the data qubit and increasing the speed at which quantum operations can be performed.

In one or more embodiments of the above-described method, the measurement qubit can comprise a frequency tunable qubit. An advantage of such a device is that by utilizing a frequency tunable qubit as the measurement qubit, the detuning between the measurement qubit and the measurement resonator can be optimized to minimize leakage during readout operations.

According, to another embodiment, a tune up method for a two qubit system can comprise tuning a coupler into a regime with finite coupling; applying a Hadamard gate to a measurement qubit coupled to a first end of the coupler; applying a probe tone to a data qubit coupled to a second end of the coupler; applying a tone at a frequency of the measurement qubit to a charge line of the data qubit; and applying a second Hadamard gate to the measurement qubit. An advantage of such a method is that the measurement qubit can be utilized to readout information from the data qubit, without the data qubit being directly coupled to a measurement resonator.

### DESCRIPTION OF THE DRAWINGS

FIG. 1 illustrates a diagram of a system for a two qubit readout in accordance with one or more embodiments described herein.

FIG. 2 illustrates a timeline for a two qubit readout method in accordance with one or more embodiments described herein.

FIG. 3 illustrates an alternative diagram of a system for a two qubit readout in accordance with one or more embodiments described herein.

FIG. 4 illustrates a chart of frequencies of a measurement qubit, a data qubit and a measurement resonator in accordance with one or more embodiments described herein.

FIG. 5 illustrates a chart of a reset procedure for a measurement qubit with a tunable frequency in accordance with one or more embodiments described herein.

FIG. 6 illustrates a graph comparing circuit fidelity of a one qubit readout with a two qubit readout as described herein.

FIG. 7 illustrates a graph comparing circuit fidelity of a one qubit readout with a two qubit readout as described herein.

FIG. 8 illustrates a graph comparing circuit fidelity of a one qubit readout with a two qubit readout as described herein.

FIG. 9 illustrates a flow diagram of an example, non-limiting, readout method for a system with two qubits as described herein.

FIG. 10 illustrates a flow diagram of an example, non-limiting, quantum tune up method for a system with two qubits as described herein.

FIG. 11 illustrates an example, non-limiting environment for the execution of at least some of the computer code in accordance with one or more embodiments described herein.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Quantum computing is generally the use of quantum-mechanical phenomena for the purpose of performing computing and information processing functions. Quantum computing can be viewed in contrast to classical computing, which generally operates on binary values with transistors. That is, while classical computers can operate on bit values that are either 0 or 1, quantum computers operate on quantum bits (qubits) that comprise superpositions of both 0 and 1, can entangle multiple quantum bits, and use interference.

A qubit is measured when its state is converted to a classical signal indicating whether the qubit was in the |0> or |1> state. During measurement, the qubit collapses to either of those states (with probabilities given by the wavefunction amplitudes) and therefore does not retain phase coherence during measurement. A common method for measuring a qubit is to couple it to a resonator. The frequency of the qubit is far detuned from the resonator and the frequency of the resonator is then weakly dependent on the state of the qubit. The qubit is therefore measured by interrogating the resonator with a classical microwave drive and the frequency shift of the resonator determined by a classical interferometer. The Hamiltonian in the dispersive limit of the resonator can be defined as

$$H = {ω}_{0} {n}_{0} + \frac{{α}_{0} {n}_{0} ( {n}_{0} - 1 )}{2} + {ω}_{B U S} ( 1 + 2 χ {n}_{0} ) {b}_{i}^{†} {b}_{i} ,$$

wherein 2Xn₀ is the measurement strength. x is set based on the coupling between the qubit and the resonator, and K is a term set by the output coupling (e.g., between the resonator and a classical system) based on the formula K,

$${Q}_{r} = \frac{{ω}_{r}}{κ}$$

and determines now lossy the resonator is. An optimal measurement occurs when K=2× with an SNR (quantum efficiency set to unity) of 4nTₘX (where n is the number of photons in steady state) where Tₘ is the measurement time. Therefore, increasing K, x is important for measurement fidelity and speed. However, as x increases, the same process which allows good measurement can also increase the rate of dephasing when there are thermal photons in the resonator (nₜₕ). K, X cannot simply be continually increased to improve measurement of the qubit. Accordingly, for quantum computing, it is preferable to have fast, high-fidelity measurements. However, the conditions for this are incompatible with good qubit operation.

Given the problems described above with prior art technologies, the present disclosure can be implemented to produce a solution to these problems with a system comprising a data qubit, a coupler coupling the data qubit to a measurement qubit, and a measurement resonator coupled to the measurement qubit. Therefore, in order to measure the data qubit, the probabilities of the |0> or |1> state of the data qubit can be transferred to the measurement qubit, and then read from the measurement qubit to a classical system utilizing the measurement resonator. By using separate qubits for data operations (e.g., the data qubit) and for measurement (e.g., the measurement qubit), the data qubit can be utilized for further operations after transferring probabilities of the |0> or |1> state to the measurement qubit. This allows for further use of the data qubit, after the measurement has projected the qubit but while the measurement qubit is still being measured, separating the idle time of the data qubit from the measurement time. Furthermore, the measurement qubit can be designed with larger K, X terms, as these changes will not impact the data qubit's performance.

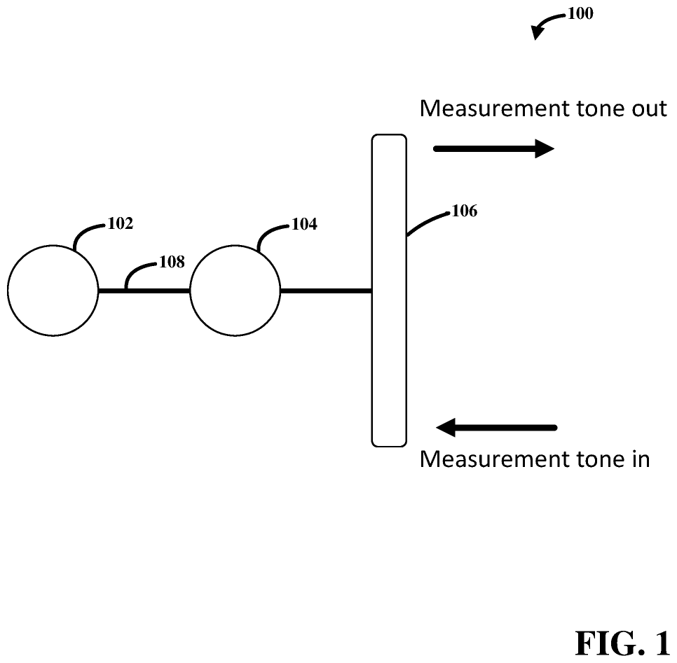

FIG. 1 illustrates a diagram of a system 100 for a two qubit readout in accordance with one or more embodiments described herein. As shown, system 100 comprises a data qubit 102, a measurement qubit 104, a coupler 108 and a measurement resonator 106. Data qubit 102 can be utilized to perform gate operations with other data qubits as part of a larger quantum computer. Measurement qubit 104 can be utilized to allow for fast, high fidelity readouts of data qubit 102. In an embodiment, measurement qubit 104 can be designed or optimized for measurement operations. For example, measurement qubit 104 can be designed with high K, X as this will not negatively impact performance of data qubit 102. Similarly, data qubit 102 can be optimized for performance of gate operations without need to make tradeoffs for measurements. In an embodiment, data qubit 102 and measurement qubit 104 can be minimally coupled prior to a measurement operation. To perform a measurement, data qubit 102 and measurement qubit 104 can be strongly coupled in order to perform a CX gate between the two qubits to transfer the computational state information from data qubit 102 to measurement qubit 104. A measurement tone or pulse can then be applied to measurement resonator 106 which projects data qubit 102 and measurement qubit 104 into the |0> or |1> state which measures the state probabilities of data qubit 102 before the CX gate.

In one or more embodiments, coupler 108 can comprise a tunable coupler and measurement qubit 104 can comprise a fixed frequency qubit. For example, coupler 108 can comprise a tunable resonator, or any tunable coupler that allows for J/ZZ vary from 0-> a finite value. In this example, coupling between data qubit 102 and measurement qubit 104 can be turned “off” and “on” based on the tuning of coupler 108. In another embodiment, coupler 108 can comprise a fixed or static coupler and measurement qubit 104 can comprise a frequency or flux tunable qubit. For example, measurement qubit 104 can have a lower sweet spot within a defined range of the frequency of data qubit 102 and an upper sweet spot close to the frequency of coupler 108. In this example, coupling between data qubit 102 and measurement qubit 104 can be turned “off” and “on” based on whether measurement qubit is far detuned (e.g., greater than 0.5 GHZ) from data qubit 102.

An advantage of such a system is that the negative impact of leakage can be decreased. Leakage is when a transmon occupies a level higher than the qubit subspace, that is not 0 or 1. This can occur when a resonance occurs allowing photons to swap from the resonator to the qubit, and measurement operations are one of the biggest sources of leakage. By using a dedicated measurement qubit, the data qubit is less prone to leakage, thereby reducing the severity of leakage and improving performance of the quantum computer. Leakage is also sensitive to detuning. Accordingly, by utilizing a flux tunable qubit as measurement qubit 104, the detuning between measurement qubit 104 and measurement resonator 106 can be optimized to minimize leakage during readout operations.

A further advantage of such a system is that multiplexed data qubits are protected from unintended readout errors. In multiplexed quantum systems utilizing single qubit readout schemes, measurement of a qubit can induce errors in qubits coupled to the measured qubit. By utilizing measurement qubit 104 for readout operations, additional data qubits coupled to data qubit 102 are shielded from this issue, thereby reducing errors within the quantum system.

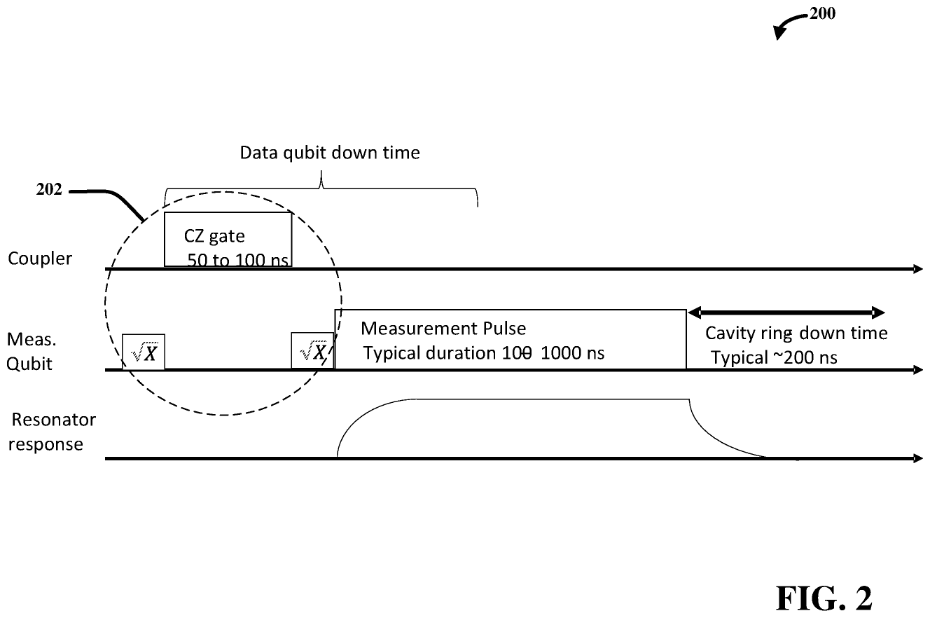

FIG. 2 illustrates a timeline 200 for a two qubit readout method in accordance with one or more embodiments described herein. At 210, a CX gate operation can be executed between measurement qubit 104 and data qubit 102 comprising two √X operations and a CZ gate. As shown, once the data qubit down time is over, data qubit 102 can be utilized for other operations. In existing measurement/readout schemes, the data qubit would be directly coupled to the measurement resonator and would not be ready for further use until after the measurement pulse and resonator ring-down time. For example, if the data qubit was directly coupled to a measurement resonator, a readout operation would take approximately 1000 ns for a measurement pulse and a further 200 ns for resonator ring down time. In contrast, with the two qubit readout scheme described above, the time usage of data qubit is approximately 50 ns for performance of the CZ gate, 25 ns for the performance of the √X gate, and 75 ns for the measurement pulse to project data qubit 102 the |0> or |1> state, for a total time usage of 150 ns. Accordingly, the method described herein allows for faster re-use of data qubit 102, thereby enabling faster use of a quantum computer which system 100 is a part of. For example, consider data qubit 102 is in an arbitrary superposition α|0 [symbol] +|1 [symbol] and measurement qubit 104 in |0 [symbol] . In |d, m [symbol] notation, the initial state is α|0,0 [symbol] +β|1,0 [symbol] . After performance of the CX gate, the state is α|0,0 [symbol] +β|1,1 [symbol] . When measurement qubit 104 is measured, both qubits are projected with the probability of |α|²|0,0 [symbol] and probability of |β|²|1,1 [symbol] . Once the readout has projected measurement qubit 104, the states are separable again and the entanglement between data qubit 102 and measurement qubit 104 is broken. Operations on data qubit 102 can then be resumed.

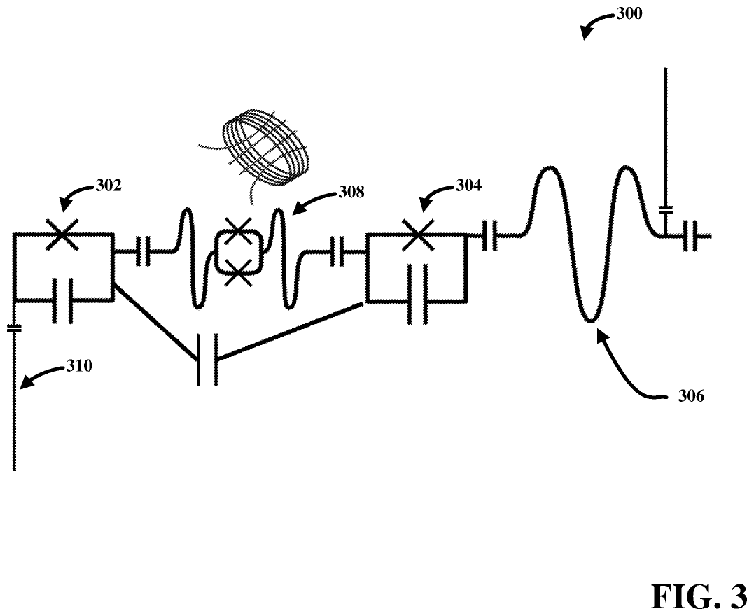

FIG. 3 illustrates an alternative diagram of a system 300 for a two qubit readout in accordance with one or more embodiments described herein.

As shown, system 300 comprises a data qubit 302, a measurement qubit 304, a tunable coupler 308 which couples data qubit 302 and measurement qubit 304, a measurement resonator 306 coupled to measurement qubit 304 and an independent drive line 310 for data qubit 302. As data qubit 302 lacks a measurement resonator, traditional tune up procedures cannot be used. Accordingly, system 300 can be tuned based on the following. First, coupler 308 can be tuned into a regime with finite coupling. Second, a Hadamard gate can be applied to measurement qubit 304. Third, a probe tone can be applied to data qubit 302. Fourth, a tone at the frequency of measurement qubit 304 can be applied on drive line 310 to data qubit 302. Fifth, a second Hadamard gate can be applied to measurement qubit 302. Then the state of measurement qubit 304 will change when the probe tone in step 3 is in resonance with the frequency of data qubit 302. The second through fifth steps can then be repeated to tune up X π/2 and X pulses on data qubit 302 which can then be utilized to tune up the CZ gate used in measurement operations as described above in relation to FIGS. 1 and 2. Once the CZ gate has been tuned up to an appropriate level of performance, the tune up procedure can end.

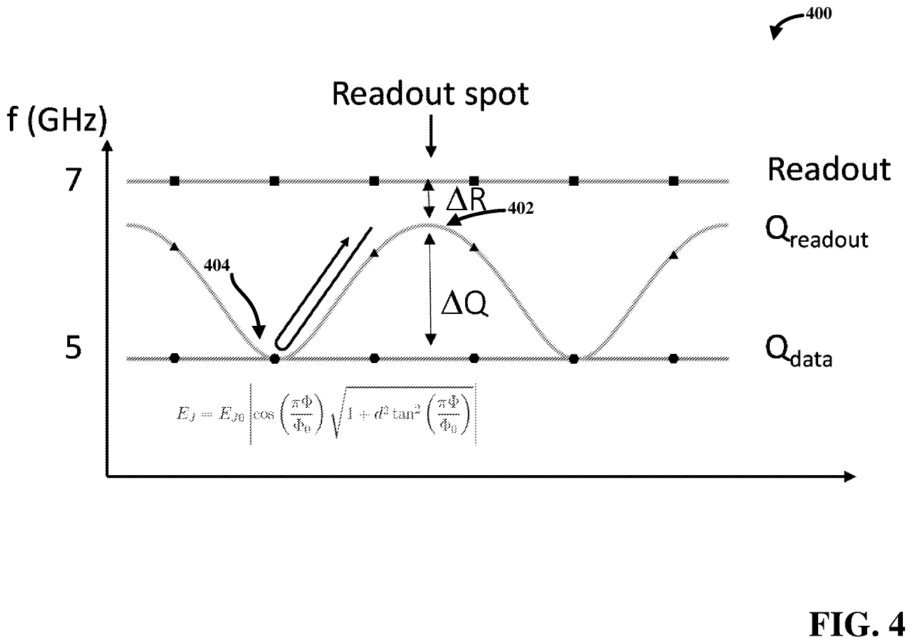

FIG. 4 illustrates chart 400 of frequencies of a measurement qubit, a data qubit and a measurement resonator in accordance with one or more embodiments described herein.

As described above in relation to FIG. 1, in one or more embodiments, measurement qubit 104 can be a frequency tunable qubit, while measurement resonator 106 and data qubit 102 are fixed frequency. As shown in chart 400, the readout frequency (e.g., frequency of measurement resonator 106) and the frequency of data qubit 102 are fixed at 7 GHz and 5 GHz respectively. In contrast, measurement qubit 104 (shown here as readout qubit) has a tunable frequency that has an upper sweet spot 402 that allows for strong coupling with measurement resonator 106 and a lower sweet spot 404 that allows for strong coupling with data qubit 102. Accordingly, the coupling between data qubit 102 and measurement qubit 104 can be turned on by driving measurement qubit 104 at lower sweet spot 404 and turned off by driving measurement qubit 104 at upper sweet spot 402.

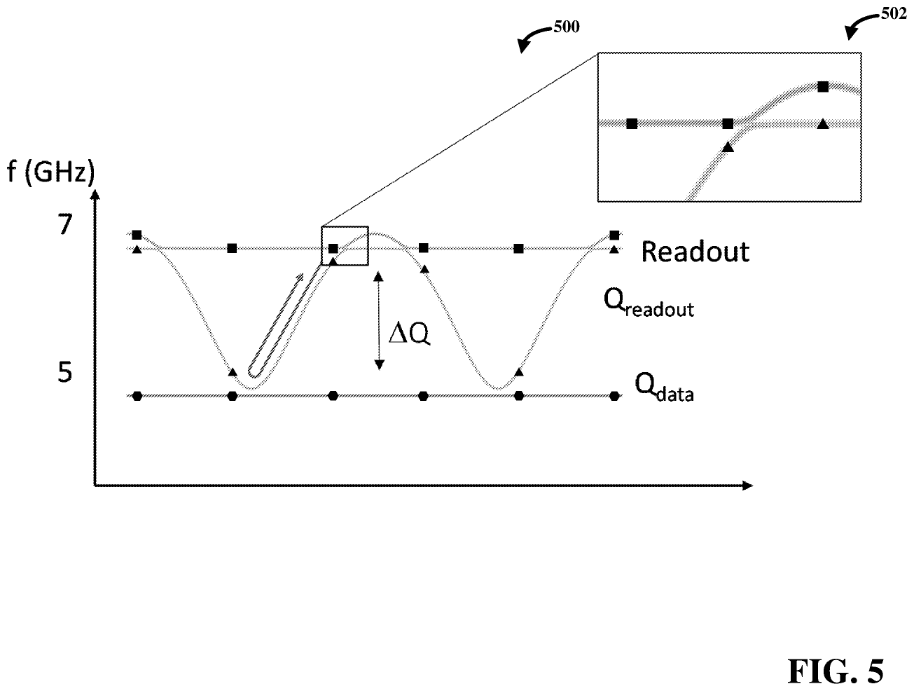

FIG. 5 illustrates a chart 500 of a reset procedure for a measurement qubit with a tunable frequency in accordance with one or more embodiments described herein.

In one or more embodiments, the upper sweet spot of measurement qubit 104 can be above the frequency of measurement resonator 106. In this embodiment, if measurement qubit 104 is brought completely into resonance with measurement resonator 106 (e.g., pushed past the frequency of measurement resonator as shown in cutout 502), then a rapid energy exchange takes place between measurement qubit 104 and measurement resonator 106 allowing for measurement qubit 104 to rapidly decay to its ground state.

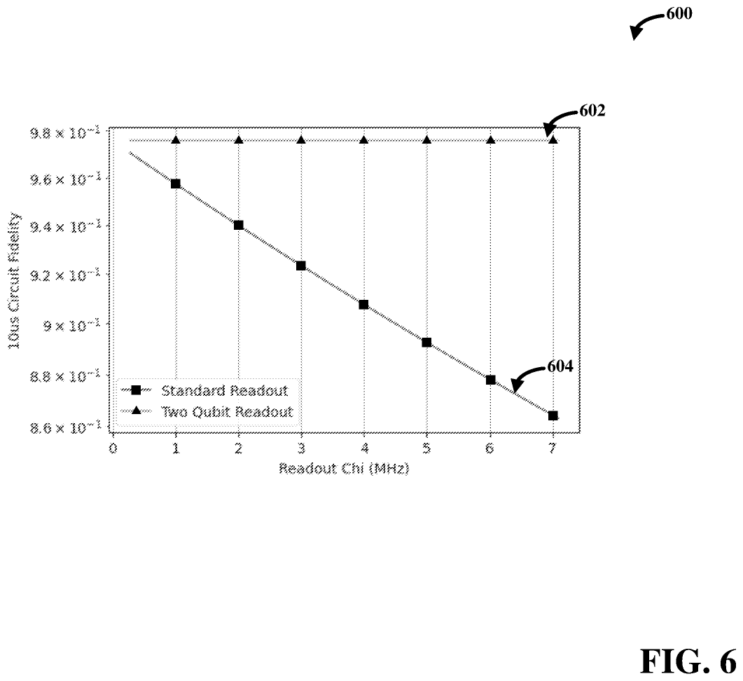

FIG. 6 illustrates a graph 600 comparing circuit fidelity of a one qubit readout with a two qubit readout as described herein.

As shown, the x-axis of graph 600 shows readout x and the y-axis of graph 600 illustrates circuit fidelity given a thermal photon population in the resonator of 10⁻³. Line 602 illustrates a two qubit readout system as described herein and line 604 shows a single qubit readout. As shown, as x is increased, circuit fidelity of the standard readout decreases severely while the circuit fidelity of the two qubit readout system remains high.

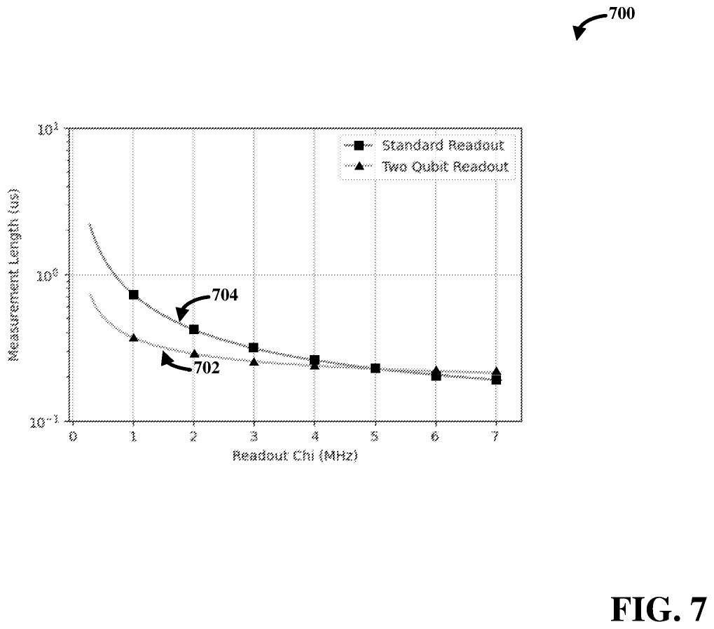

FIG. 7 illustrates a graph 700 comparing circuit fidelity of a one qubit readout with a two qubit readout as described herein.

As shown, the y-axis of graph 700 illustrates measurement length (e.g., measurement speed) and the x-axis of graph 700 shows readout x. Line 702 illustrates a two qubit readout system as described herein and line 704 shows a single qubit readout. As shown, the two qubit readout is faster at x below 5 MHz and remains similar in speed past approximately 150 ns.

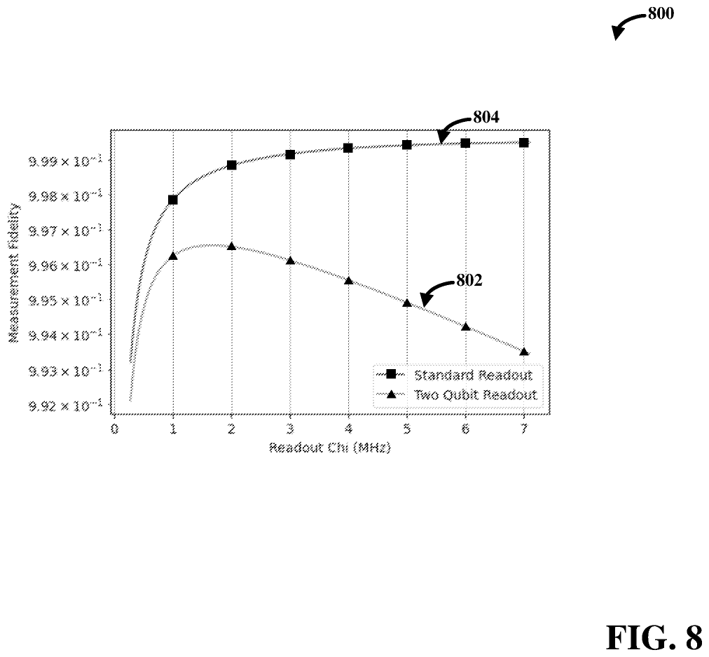

FIG. 8 illustrates a graph 800 comparing measurement fidelity of a one qubit readout with a two qubit readout as described herein.

As shown, the y-axis of graph 800 illustrates measurement fidelity and the x-axis of graph 800 shows readout x. Line 802 illustrates a two qubit readout system as described herein and line 804 shows a single qubit readout. As shown, the two qubit readout will have slightly degraded measurement fidelity by definition as it includes a two qubit gate. However, as the probabilities of the |0> or |1> state are still accurately measured, this slight loss of fidelity does not impact overall performance.

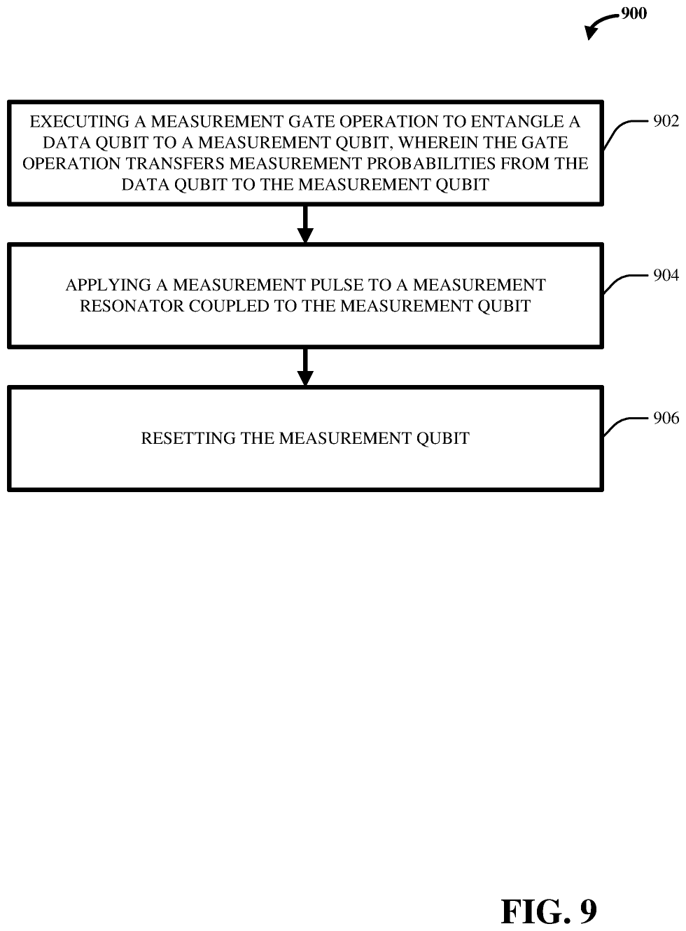

FIG. 9 illustrates a flow diagram of an example, non-limiting, readout method 900 for a system with two qubits as described herein.

At 902, method 900 can comprise, executing a measurement gate operation to entangle a data qubit (e.g., data qubit 102 and 302) to a measurement qubit (e.g., measurement qubit 104 and 304), wherein the gate operation transfers measurement probabilities from the data qubit to the measurement qubit. For example, as described above in reference to FIGS. 1-4, a data qubit and a measurement qubit can be strongly coupled and a CX gate can be executed between the data qubit and the measurement qubit to transfer information stored in the data qubit to the measurement qubit.

At 904, method 900 can comprise, applying a measurement pulse to a measurement resonator (e.g., measurement resonator 106 and 306) coupled to the measurement qubit. For example, as described above in relation to FIGS. 1-4, a measurement tone can be applied to the measurement resonator that projects the data qubit and the measurement qubit into the |0> or |1> state which measures the state probabilities of the data qubit before the CX gate. Once this tone has been applied, the data qubit and the measurement qubit can be uncoupled, and the data qubit can be used for further operations.

At 906, method 900 can comprise resetting the measurement qubit. For example, as described above in relation to FIGS. 1 and 5, if the measurement qubit comprises a flux tunable qubit, then the measurement qubit can be brought completely into resonance with the measurement resonator, and a rapid energy exchange takes place between the measurement qubit and the measurement resonator allowing for the measurement qubit to rapidly decay to its ground state. If the measurement qubit is a static qubit, then a measurement-based conditional reset pulse can be performed to reset the measurement qubit.

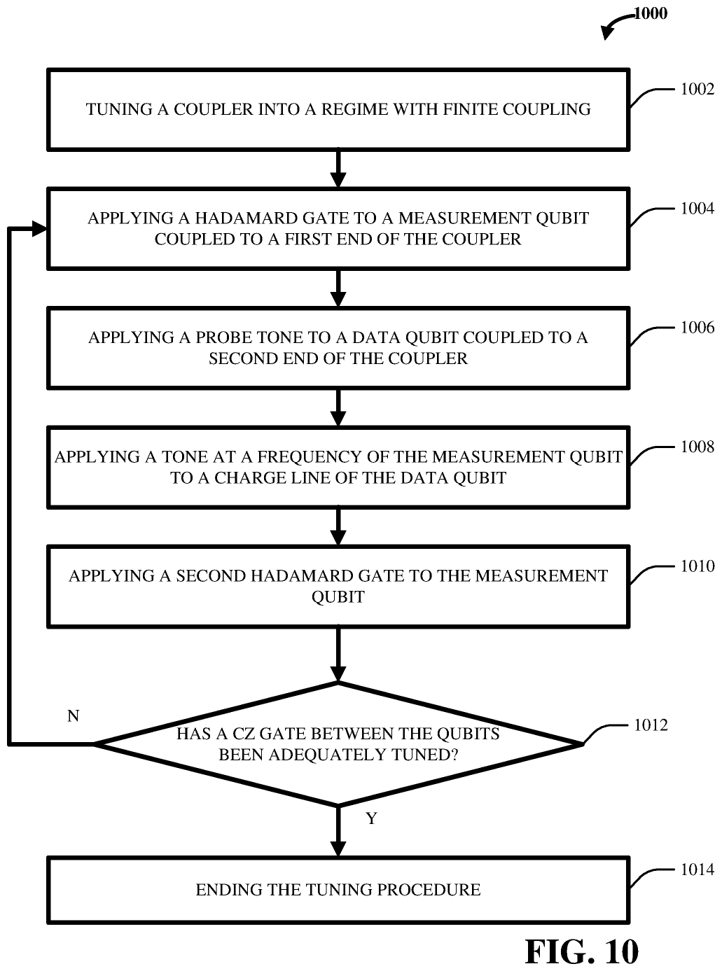

FIG. 10 illustrates a flow diagram of an example, non-limiting, quantum tuning method 1000 for a system with two qubits as described herein.

At 1002, method 1000 can comprise tuning a coupler (e.g., coupler 308) into a regime with finite coupling.

At 1004, method 1000 can comprise applying a Hadamard gate to a measurement qubit (e.g., measurement qubit 304) coupled to a first end of the coupler.

At 1006, method 1000 can comprise applying a probe tone to a data qubit (e.g., data qubit 302) coupled to a second end of the coupler.

At 1008, method 1000 can comprise applying a tone at a frequency of the measurement qubit to a charge line of the data qubit.

At 1010, method 1000 can comprise applying a second Hadamard gate to the measurement qubit (e.g., measurement qubit 304).

At 1012, method 1000 can comprise determining if a CZ gate between the qubits has been adequately tuned. This determination can be based on performance characteristics of a CZ gate operated between the data qubit and the measurement qubit. In response to a YES determination, the tuning procedure can end at step 1014. In response to a NO determination, method 1000 can return to step 1004 to continuing the tuning.

A practical application of the devices and/or systems described herein is that they allow for quantum computers with improved performance and/or reduced errors. For example, the measurement qubit can be designed with high K, x as this will not negatively impact performance of the data qubit. Similarly, data qubit 102 can be optimized for performance of gate operations without need to make trade offs for measurements. This allows for design of systems with high fidelity, fast readouts that do not require trade offs in performance of quantum computations, in contrast to other systems. Additionally, the use of a measurement qubit enables the data qubit to resume other operations without having to wait for the measurement resonator to ring down, thereby decreasing idle time of the data qubit and improving speed of the quantum computer.

Furthermore, usage of a measurement qubit enables reduction of leakage and unintended errors in multiplexed systems. For example, by using a dedicated measurement qubit, the data qubit is less prone to leakage, thereby reducing the severity of leakage and improving performance of the quantum computer. As leakage is sensitive to detuning, by utilizing a flux tunable qubit as the measurement qubit, the detuning between the measurement qubit and the measurement resonator can be optimized to minimize leakage during readout operations. Additionally, by utilizing the measurement qubit for readout operations, additional data qubits coupled to the data qubit are shielded from unintended multiplexing readout errors, thereby reducing errors within the quantum system.

The various embodiments of the subject disclosure described herein and/or illustrated in the figures (e.g., systems 100, 300 etc.) can be coupled to one or more external devices (not illustrated in FIGS. 1 and 3) to facilitate operation of such embodiments. For example, with reference to FIG. 1, system 100, data qubit 102, measurement qubit 104, measurement resonator 106 and/or coupler 108 can be coupled to one or more external devices that can be external to system 100, such as for instance, a pulse generator device, an electrical current source, and/or a frequency generator.

In an example embodiment, although not depicted in FIG. 1, system 100, data qubit 102, measurement qubit 104, measurement resonator 106 and/or coupler 108 can be coupled to a pulse generator device including, but not limited to, an arbitrary waveform generator (AWG), a vector network analyzer (VNA), and/or another pulse generator device that can be external to system 100 and can transmit and/or receive pulses (e.g., microwave pulses, microwave signals, control signals, etc.) to and/or from system 100, data qubit 102, measurement qubit 104, measurement resonator 106 and/or coupler 108. In another example embodiment, although not depicted in FIG. 1, system 100, data qubit 102, measurement qubit 104, measurement resonator 106 and/or coupler 108 can be coupled to an electrical current source and/or a frequency synthesizer that can be external to system 100 and can provide an electrical current, an electrical potential, and/or a magnetic field to system 100, data qubit 102, measurement qubit 104, measurement resonator 106 and/or coupler 108.

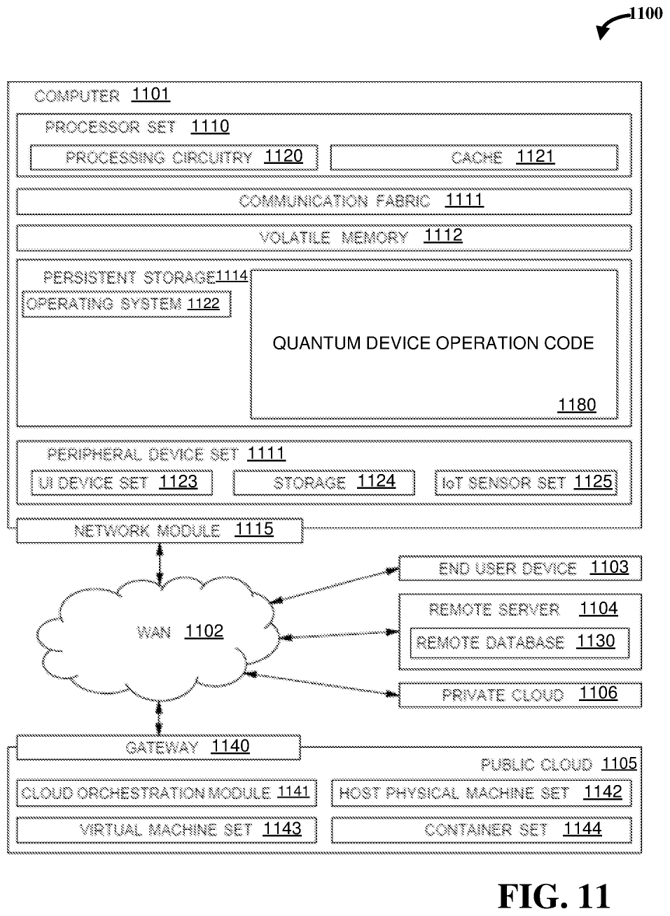

In the example embodiments above, such one or more external devices (e.g., a pulse generator device (e.g., an AWG, a VNA, etc.), an electrical current source, and/or a frequency synthesizer) can also be coupled to a computer (e.g., computer 1101 described below with reference to FIG. 11) comprising a memory (e.g., persistent storage 1114 and/or volatile memory 1112 described below with reference to FIG. 11) that can store instructions thereon (e.g., software, routines, processing threads, etc.) and a processor (e.g., processor set 1110 described below with reference to FIG. 11) that can execute such instructions that can be stored on the memory. In these example embodiments, such a computer can be employed to operate and/or control (e.g., via executing instructions stored on persistent storage 1114 and/or volatile memory 1112) such one or more external devices (e.g., a pulse generator device (e.g., an AWG, a VNA, etc.), an electrical current source, and/or a frequency synthesizer). For instance, in these example embodiments, such a computer can be employed to enable one or more external devices (e.g., a pulse generator device (e.g., an AWG, a VNA, etc.), an electrical current source, and/or a frequency synthesizer) to: a) transmit and/or receive pulses (e.g., microwave pulses, microwave signals, control signals, etc.) to and/or from system 100, data qubit 102, measurement qubit 104, measurement resonator 106 and/or coupler 108 and/or b) provide an electrical current, an electrical potential, and/or a magnetic field to system 100, data qubit 102, measurement qubit 104, measurement resonator 106 and/or coupler 108.

In various embodiments, an entity that implements systems 100 and/or 300 (e.g., an entity such as, for instance, a human, a computing device, a software application, an agent, a machine learning model, an artificial intelligence model, etc.) can implement one or more of the entangling gate schemes described herein in accordance with one or more embodiments of the subject disclosure. In these embodiments, such an entity can implement one or more of such entangling gate schemes by applying and/or adjusting (e.g., via one or more of the above defined external devices and/or computer 1101 as described above) a magnetic field, an electrical current, an electrical potential, and/or a microwave pulse applied to systems 100, 300 and/or one or more components thereof.

FIG. 11 and the following discussion are intended to provide a brief, general description of a suitable computing environment 1100 in which one or more embodiments described herein can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1100 contains an example of an environment for the execution of at least some of the computer code involved in performing the inventive methods, such as translation of an original source code based on a configuration of a target system by the quantum device operation code 1180. In addition to block 1180, computing environment 1100 includes, for example, computer 1101, wide area network (WAN) 1102, end user device (EUD) 1103, remote server 1104, public cloud 1105, and private cloud 1106. In this embodiment, computer 1101 includes processor set 1110 (including processing circuitry 1120 and cache 1121), communication fabric 1111, volatile memory 1112, persistent storage 1113 (including operating system 1122 and block 1180, as identified above), peripheral device set 1114 (including user interface (UI), device set 1123, storage 1124, and Internet of Things (IoT) sensor set 1125), and network module 1115. Remote server 1104 includes remote database 1130. Public cloud 1105 includes gateway 1140, cloud orchestration module 1141, host physical machine set 1142, virtual machine set 1143, and container set 1144.

COMPUTER 1101 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1130. As is well understood in the art of computer technology, and depending upon the technology, performance of a computer-implemented method can be distributed among multiple computers and/or between multiple locations. On the other hand, in this presentation of computing environment 1100, detailed discussion is focused on a single computer, specifically computer 1101, to keep the presentation as simple as possible. Computer 1101 can be located in a cloud, even though it is not shown in a cloud in FIG. 11. On the other hand, computer 1101 is not required to be in a cloud except to any extent as can be affirmatively indicated.

PROCESSOR SET 1110 includes one, or more, computer processors of any type now known or to be developed in the future. Processing circuitry 1120 can be distributed over multiple packages, for example, multiple, coordinated integrated circuit chips. Processing circuitry 1120 can implement multiple processor threads and/or multiple processor cores. Cache 1121 is memory that is located in the processor chip package(s) and is typically used for data or code that should be available for rapid access by the threads or cores running on processor set 1110. Cache memories are typically organized into multiple levels depending upon relative proximity to the processing circuitry. Alternatively, some, or all, of the cache for the processor set can be located “off chip.” In some computing environments, processor set 1110 can be designed for working with qubits and performing quantum computing.

Computer readable program instructions are typically loaded onto computer 1101 to cause a series of operational steps to be performed by processor set 1110 of computer 1101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1121 and the other storage media discussed below. The program instructions, and associated data, are accessed by processor set 1110 to control and direct performance of the inventive methods. In computing environment 1100, at least some of the instructions for performing the inventive methods can be stored in block 1180 in persistent storage 1113.

COMMUNICATION FABRIC 1111 is the signal conduction path that allows the various components of computer 1101 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths and/or wireless communication paths.

VOLATILE MEMORY 1112 is any type of volatile memory now known or to be developed in the future. Examples include dynamic type random access memory (RAM) or static type RAM. Typically, the volatile memory is characterized by random access, but this is not required unless affirmatively indicated. In computer 1101, the volatile memory 1112 is located in a single package and is internal to computer 1101, but, alternatively or additionally, the volatile memory can be distributed over multiple packages and/or located externally with respect to computer 1101.

PERSISTENT STORAGE 1113 is any form of non-volatile storage for computers that is now known or to be developed in the future. The non-volatility of this storage means that the stored data is maintained regardless of whether power is being supplied to computer 1101 and/or directly to persistent storage 1113. Persistent storage 1113 can be a read only memory (ROM), but typically at least a portion of the persistent storage allows writing of data, deletion of data and re-writing of data. Some familiar forms of persistent storage include magnetic disks and solid-state storage devices. Operating system 1122 can take several forms, such as various known proprietary operating systems or open-source Portable Operating System Interface type operating systems that employ a kernel. The code included in block 1180 typically includes at least some of the computer code involved in performing the inventive methods.

PERIPHERAL DEVICE SET 1114 includes the set of peripheral devices of computer 1101. Data communication connections between the peripheral devices and the other components of computer 1101 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1123 can include components such as a display screen, speaker, microphone, wearable devices (such as goggles and smart watches), keyboard, mouse, printer, touchpad, game controllers, and haptic devices. Storage 1124 is external storage, such as an external hard drive, or insertable storage, such as an SD card. Storage 1124 can be persistent and/or volatile. In some embodiments, storage 1124 can take the form of a quantum computing storage device for storing data in the form of qubits. In embodiments where computer 1101 is required to have a large amount of storage (for example, where computer 1101 locally stores and manages a large database) then this storage can be provided by peripheral storage devices designed for storing large amounts of data, such as a storage area network (SAN) that is shared by multiple, geographically distributed computers. IoT sensor set 1125 is made up of sensors that can be used in Internet of Things applications. For example, one sensor can be a thermometer and another sensor can be a motion detector.

NETWORK MODULE 1115 is the collection of computer software, hardware, and firmware that allows computer 1101 to communicate with other computers through WAN 1102. Network module 1115 can include hardware, such as modems or Wi-Fi signal transceivers, software for packetizing and/or de-packetizing data for communication network transmission, and/or web browser software for communicating data over the internet. In some embodiments, network control functions and network forwarding functions of network module 1115 are performed on the same physical hardware device. In other embodiments (for example, embodiments that utilize software-defined networking (SDN)), the control functions and the forwarding functions of network module 1115 are performed on physically separate devices, such that the control functions manage several different network hardware devices. Computer readable program instructions for performing the inventive methods can typically be downloaded to computer 1101 from an external computer or external storage device through a network adapter card or network interface included in network module 1115.

WAN 1102 is any wide area network (for example, the internet) capable of communicating computer data over non-local distances by any technology for communicating computer data, now known or to be developed in the future. In some embodiments, the WAN can be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1103 is any computer system that is used and controlled by an end user (for example, a customer of an enterprise that operates computer 1101) and can take any of the forms discussed above in connection with computer 1101. EUD 1103 typically receives helpful and useful data from the operations of computer 1101. For example, in a hypothetical case where computer 1101 is designed to provide a recommendation to an end user, this recommendation would typically be communicated from network module 1115 of computer 1101 through WAN 1102 to EUD 1103. In this way, EUD 1103 can display, or otherwise present, the recommendation to an end user. In some embodiments, EUD 1103 can be a client device, such as thin client, heavy client, mainframe computer and/or desktop computer.

REMOTE SERVER 1104 is any computer system that serves at least some data and/or functionality to computer 1101. Remote server 1104 can be controlled and used by the same entity that operates computer 1101. Remote server 1104 represents the machine(s) that collect and store helpful and useful data for use by other computers, such as computer 1101. For example, in a hypothetical case where computer 1101 is designed and programmed to provide a recommendation based on historical data, then this historical data can be provided to computer 1101 from remote database 1130 of remote server 1104.

PUBLIC CLOUD 1105 is any computer system available for use by multiple entities that provides on-demand availability of computer system resources and/or other computer capabilities, especially data storage (cloud storage) and computing power, without direct active management by the scale. The direct and active management of the computing resources of public cloud 1105 is performed by the computer hardware and/or software of cloud orchestration module 1141. The computing resources provided by public cloud 1105 are typically implemented by virtual computing environments that run on various computers making up the computers of host physical machine set 1142, which is the universe of physical computers in and/or available to public cloud 1105. The virtual computing environments (VCEs) typically take the form of virtual machines from virtual machine set 1143 and/or containers from container set 1144. It is understood that these VCEs can be stored as images and can be transferred among and between the various physical machine hosts, either as images or after instantiation of the VCE. Cloud orchestration module 1141 manages the transfer and storage of images, deploys new instantiations of VCEs and manages active instantiations of VCE deployments. Gateway 1140 is the collection of computer software, hardware and firmware allowing public cloud 1105 to communicate through WAN 1102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1106 is similar to public cloud 1105, except that the computing resources are only available for use by a single enterprise. While private cloud 1106 is depicted as being in communication with WAN 1102, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1105 and private cloud 1106 are both part of a larger hybrid cloud. The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system comprising:
a data qubit;
a coupler coupling the data qubit to a measurement qubit; and
a measurement resonator coupled to the measurement qubit, wherein a measurement tone applied to the measurement resonator, acquires a change in phase or amplitude that depends on the state of the measurement qubit.

2. The system of claim 1, wherein the data qubit is utilized for performing quantum gates.

3. The system of claim 1, wherein the measurement qubit utilized for measuring a state of the data qubit.

4. The system of claim 1, wherein the coupler is a tunable coupler.

5. The system of claim 1, wherein the coupler is a fixed coupler.

6. The system of claim 5, wherein the measurement qubit is a frequency tunable qubit.

7. The system of claim 6, wherein the measurement qubit has a lower sweet spot within a defined range of a frequency of the data qubit and an upper sweet spot within a second defined range of a frequency of the measurement resonator.

8. The system of claim 1, wherein the data qubit is coupled to an independent drive line.

9. A method of measuring a data qubit comprising:
executing a measurement gate operation to entangle the data qubit to a measurement qubit, wherein the gate operation transfers measurement probabilities from the data qubit to the measurement qubit; and
applying a measurement pulse to a measurement resonator coupled to the measurement qubit.

10. The method of claim 9, wherein the data qubit and the measurement qubit are minimally coupled prior to executing the measurement gate operation.

11. The method of claim 9, wherein the applying the measurement pulse comprises: applying a tone to the measurement resonator which projects the measurement qubit and the data qubit into the |0> or |1> state.

12. The method of claim 9, wherein the measurement gate operation comprises:
executing a CX gate between the data qubit and the measurement qubit to transfer information stored in the data qubit to the measurement qubit.

13. The method of claim 12, further comprising:
resetting the measurement qubit.

14. The method of claim 10, wherein the data qubit is coupled to an independent drive line.

15. The method of claim 13, wherein the measurement qubit is a tunable qubit.

16. The method of claim 15, wherein the resetting comprises pushing a frequency of the measurement qubit past a frequency of the measurement resonator.

17. The method of claim 16, wherein the tunable qubit has a lower sweet spot within a defined range of a frequency of the data qubit and an upper sweet spot within a second defined range of a frequency of the measurement resonator.

18. A method comprising:
tuning a coupler into a regime with finite coupling;
applying a Hadamard gate to a measurement qubit coupled to a first end of the coupler;
applying a probe tone to a data qubit coupled to a second end of the coupler;
applying a tone at a frequency of the measurement qubit to a charge line of the data qubit; and
applying a second Hadamard gate to the measurement qubit.

19. The method of claim 18, wherein the measurement qubit is a fixed qubit.

20. The method of claim 18 wherein the data qubit is not coupled to a measurement resonator.
